(19) United States
(12) Patent Application Publication
(10) Pub. No.: US 2005/0129892 A1
(43) Pub. Date: Jun. 16, 2005

(54) Adhesive-coated, contamination-control mat assembly having new and improved tab means for facilitating the separation of the underlying base release sheet

(75) Inventor: Martin D. Beyer, Acworth, GA (US)

Correspondence Address: Steven W. Weinrieb;SCHWARTZ & WEINRIEB, 2001 Jefferson Davis Highway, Crystal Plaza One, Suite 1109, Arlington, VA, 22202, US

(73) Assignee: ILLINOIS TOOL WORKS INC

(21) Appl. No.: 10/733,392

(22) Filed: Dec. 12, 2003

(51) Int. Cl. B32B 9/00

(52) U.S. Cl. 428/40.1

(57) ABSTRACT

A contamination-control mat assembly includes a stacked array of pressure-sensitive adhesive coated plastic sheets disposed upon a base member which is to be affixed upon an underlying floor support structure by an adhesive layer disposed upon an undersurface portion of the base member. A release sheet is removably disposed upon the adhesive layer so as to cover and protect the same until it is desired to remove the release sheet in order to expose the adhesive layer when the contamination-control mat assembly is to be affixed to the underlying floor support structure. In order to facilitate the removal of the release sheet from the adhesive layer disposed upon the undersurface portion of the base member, a pull-tab is adhesively bonded to an external surface portion of the release sheet so as not to be disposed in contact with the adhesive layer whereby removal of the release sheet from the adhesive layer is unimpeded and readily facilitated as a result of operator personnel grasping and manually manipulating the pull-tab.

### FIELD OF THE INVENTION

The present invention relates generally to adhesive-coated, contamination-control mat assemblies, and more particularly, to a new and improved adhesive-coated, contamination-control mat assembly, wherein the adhesive-coated, contamination-control mat assembly comprises a plurality of adhesive-coated plastic film sheets disposed upon an underlying base member which is adapted to be adhesively secured to an underlying floor support structure, and wherein further, the adhesive-coated, contamination-control mat assembly has new and improved tab structure mounted upon the external or undersurface portion of a release sheet, which initially underlies the adhesive-coated base member of the mat assembly, so as to facilitate the removal of the release sheet from the adhesive-coated base member, without adversely affecting the structural integrity of the adhesive layer disposed upon the undersurface portion of the base member, in order to readily facilitate the attachment of the adhesive-coated base member, and therefore the attachment of the adhesive-coated, contamination-control mat assembly, to the underlying floor support structure.

### BACKGROUND OF THE INVENTION

Adhesive-coated, contamination-control mats, commonly known or referred to as tacky mats, are well-known devices or implements which have been conventionally used to remove dirt, dust, and other contaminants from the soles of shoes, from the wheels of gurneys, carts, or other transportable apparatus, or from other objects, prior to the entrance of such objects or devices into “clean room” facilities in order to in fact maintain such “clean room” facilities in their desirably clean condition. Such “clean room” facilities may comprise, for example, hospital operating rooms, emergency rooms, critical patient care areas, or the like, or alternatively, laboratory or similar facilities within which microcircuitry and other delicate or sophisticated instrumentation is manufactured or assembled. Examples of such adhesive-coated contamination-control or tacky mats are disclosed within U.S. Pat. No. 4,559,250 which issued to Paige on Dec. 17, 1985, U.S. Pat. No. 3,785,102 which issued to Amos on Jan. 15, 1974, U.S. Pat. No. 3,717,897 which issued to Amos et al. on Feb. 27, 1973, U.S. Pat. No. 3,501,797 which issued to Nappi on Mar. 24, 1970, U.S. Pat. No. 3,400,421 which issued to Nappi et al. on Sep. 10, 1968, U.S. Pat. No. 3,083,393 which issued to Nappi on Apr. 2, 1963, and United Kingdom Patent Specification 1,340,636 which was published on Dec. 12, 1973 in the name of Nappi.

Conventional or PRIOR ART adhesive-coated, contamination-control mats have conventionally comprised two basic constructions. The first embodiment or type of adhesive-coated, contamination-control mat essentially comprises a relatively thick, single member or single layer mat fabricated, for example, from polyvinyl chloride (PVC), whereas the second embodiment or type of adhesive-coated, contamination-control mat essentially comprises a multi-layer laminated stack of adhesive-coated plastic film sheets. More particularly, as a result of the fabrication of the first embodiment or type of adhesive-coated, contamination-control mat as a relatively thick, single member or single layer mat, the weight and inertial mass of the mat enables the same to be simply disposed upon the underlying floor support structure without the need for adhesively bonding, for example, the undersurface portion of the mat to the underlying floor support structure. In addition, while the upper surface portion of the single member or single layer adhesive-coated, contamination-control mat is characterized by means of an adhesive layer which exhibits a relatively low-level of adhesiveness or tackiness so as to effectively remove dirt or dust either from the shoes of facility personnel, or from the wheels of gurneys, carts, or other transportable apparatus, while obviously not impeding the traversal of the same by facility personnel, or the movement thereacross of the transportable apparatus, it has been noted that when the upper surface portion of the single member or single layer adhesive-coated, contamination-control mat becomes soiled as a result of the accumulation of dirt and dust thereon, its effectiveness rapidly deteriorates.

Accordingly, such upper surface portion of the single member or single layer adhesive-coated, contamination-control mat must then be subjected to a water washing process or procedure, and appropriately dried so as to once again be capable of being used for its intended purposes. In addition to such cleaning process or procedure being time-consuming, the upper, adhesive-coated surface portion of the single member or single layer adhesive-coated, contamination-control mat tends to become eroded or worn as a result of being subjected to the repetitive cleaning processes or procedures. Still further, it is noted that the single member or single layer adhesive-coated, contamination control mat must either be replaced with another single member or single layer adhesive-coated, contamination-control mat, while the original single member or single layer adhesive-coated, contamination control mat undergoes its refurbishing or cleaning process or procedure, so as to permit the “clean-room” facility to be used continuously, or else the “clean-room” facility must be temporarily closed until the original single member or single layer adhesive-coated, contamination-control mat can again be used. Still further, since this particular adhesive-coated, contamination-control mat is characterized by means of a single member or single layer structure which has a relatively large thickness dimension, this embodiment or type of contamination-control mat often presents a trip hazard to facility personnel, or an obstacle over which the transportable apparatus must be forcefully moved. This embodiment or type of contamination-control mat has therefore not proven to be particularly desirable or viable.

With respect to the second embodiment or type of adhesive-coated, contamination-control mat assembly, a multi-layer laminated stack of adhesive-coated plastic film sheets, such as, for example, approximately thirty adhesive-coated plastic film sheets, are disposed upon an underlying base member. The adhesive-coated surface of each plastic film sheet faces upwardly, and accordingly, when the external, upwardly disposed surface of the uppermost one of the plurality of adhesive-coated plastic film sheets becomes soiled, such as, for example, when dirt and dust accumulate thereon to such a degree that the dirt and dust removal properties of such uppermost one of the plurality of adhesive-coated plastic film sheets is no longer adequately effective, then such uppermost one of the plurality of adhesive-coated plastic film sheets is simply removed from the laminated stack of adhesive-coated plastic film sheets so as to effectively uncover the next one of the plurality of adhesive-coated plastic film sheets which is obviously clean and therefore ready for immediate use. Since this embodiment or type of adhesive-coated, contamination-control mat obviously does not require any washing or cleaning, the operational drawbacks or disadvantages, characteristic of the first embodiment or type of adhesive-coated, contamination-control mat, are effectively overcome or eliminated. It is noted, however, that, in view of the fact that the uppermost ones of the adhesive-coated plastic film sheets are being continually removed from the laminated stack of adhesive-coated plastic film sheets, when it is so required, in order to maintain the adhesive properties of the adhesive-coated, contamination-control mat effective, the entire contamination-control mat assembly need not be removed from the underlying floor support structure for cleaning and washing purposes and in fact is desired to be maintained at a fixed position with respect to the entranceway into the “clean room” facility.

Accordingly, in order to ensure that the disposition of the contamination-control mat assembly is in fact properly maintained upon the underlying floor support structure at the entranceway of the “clean room” facility, the undersurface portion of the base member of the contamination-control mat assembly is adhesively bonded to the underlying floor support structure by means of a suitable adhesive layer disposed upon the undersurface portion of the base member of the contamination-control mat assembly. In order to protect the aforenoted adhesive layer, disposed upon the undersurface portion of the base member of the contamination-control mat assembly, until the adhesive-coated, contamination-control mat assembly is to be installed upon the underlying floor support structure, a suitable release member or release sheet is normally secured upon the adhesive layer so as to cover the same. Accordingly, when the contamination-control mat assembly is adapted to be affixed to the underlying floor support structure as a result of the undersurface portion of the base member of the contamination-control mat assembly being adhesively secured to the underlying floor support structure, the release member or release sheet must first be removed so as to effectively expose the adhesive layer disposed upon the undersuface portion of the base member of the contamination-control mat assembly. In order to facilitate such removal of the release member or release sheet from the undersurface portion of the adhesive-coated base member, a suitable tab structure is desirably secured or mounted upon the adhesive-coated, contamination-control mat assembly.

As disclosed within the aforenoted U.S. Pat. Nos. 3,501,797 and 3,400,421 which issued to Nappi, as well as the aforenoted United Kingdom Patent Specification 1,340,636 which was likewise published in the name of Nappi, various tab or pull structures have been employed in connection with such conventional adhesive-coated, contamination-control mats in order to easily separate each individual uppermost adhesive-coated plastic film sheet from its neighboring adhesive-coated plastic film sheet disposed immediately below the uppermost adhesive-coated plastic film sheet when it is required to remove and replace the uppermost adhesive-coated plastic film sheet, however, such tab or pull structures have not in fact been utilized in connection with the removal of a release member or release sheet from the undersurface portion of the adhesive-coated base member of the contamination-control mat assembly. More particularly, as disclosed within FIG. 1, which essentially corresponds to FIG. 4 of U.S. Pat. No. 3,501,797, upper and lower stacks 21,23 of pressure-sensitive sheets are mounted upon a foam pad 22, and strands 13,13′, having loop portions 15, as well as a strand 25, are respectively provided in order to separate the individual pressure-sensitive sheets, such as, for example, top sheet 20, from each other as well as to facilitate the separation of the lower stack 23 of pressure-sensitive sheets from the underlying floor surface whereby the lower stack 23 of pressure-sensitive sheets can now be used in an upwardly-facing mode for the desired dirt and dust removal purposes after the upper stack 21 of pressure-sensitive sheets has been depleted. In a similar manner, as disclosed within FIG. 2, which essentially corresponds to FIG. 4 of United Kingdom Patent Specification 1,340,636, folded leaf portions 44 of tab members 42, which are adhesively bonded to corner regions of each adhesive sheet of the laminated stack of adhesive-coated plastic film sheets, are provided for enabling the easy separation of the uppermost one of the adhesive-coated plastic film sheets from the remaining adhesive-coated plastic film sheets comprising the laminated stack of adhesive-coated plastic film sheets.

As has therefore been noted hereinbefore, while suitable tab or pull structures have been employed in connection with adhesive-coated, contamination-control mats in order to facilitate the separation of individual ones of the adhesive-coated plastic film sheets from the remaining adhesive-coated plastic film sheets comprising the laminated stack of adhesive-coated plastic film sheets, these types of tab or pull structures have not been utilized to separate a release member or release sheet from the adhesively-coated undersurface portion of the base member of the contamination-control mat assembly in preparation for securing the adhesive-coated, contamination-control mat assembly to the underlying floor support structure. It is noted further that other types of tab or pull structures do conventionally exist for separating the release member or release sheet from the adhesively-coated undersurface portion of the base member in preparation for securing the adhesive-coated, contamination-control mat assembly to the underlying floor support structure, however such tab or pull structures exhibit various operational difficulties and drawbacks. For example, as illustrated within FIG. 3, a conventional, PRIOR ART adhesive-coated, contamination-control mat assembly is disclosed and is generally indicated by the reference character 110. More particularly, the adhesive-coated, contamination-control mat assembly 110 is seen to comprise a base member 112 upon the upper surface of which there is disposed a stacked array of adhesive-coated plastic film sheets 114. In addition, in order to fixedly secure the contamination-control mat assembly 110 to an underlying floor support structure, the undersurface portion of the base member 112 has an adhesive layer 116 fixedly attached thereto. In addition, a release sheet 118 is normally disposed over or upon the external surface of the adhesive layer 116 so as to cover the same and thereby effectively prevent the adhesive material comprising the adhesive layer 116 from inadvertently sticking or adhering to any objects or structures prior to the intended adherence of the contamination-control mat assembly 110 to the underlying floor support structure.

In order to facilitate the removal of the release sheet 118 from the adhesive layer 116 disposed beneath or upon the undersurface portion of the base member 112 in preparation for the adherence of the contamination-control mat assembly 110 to the underlying floor support structure, a pull-tab 120 is mounted upon the contamination-control mat assembly 110 so as to be operatively connected to the underlying release sheet 118. More particularly, it is noted that in accordance with the structural arrangement characteristic of such conventional, PRIOR ART contamination-control mat assembly 110, the pull-tab 120 is mounted upon an edge portion of the contamination-control mat assembly 110 so as to be manually accessible, and it is also seen that the pull-tab 120 is interposed between the external surface portion of the adhesive layer 116 and the internal surface portion of the release sheet 118. The reason for this structural arrangement, that is, where the pull-tab 120 is interposed between the external surface portion of the adhesive layer 116 and the internal surface portion of the release sheet 118, is that the conventional pull-tabs 120 are usually fabricated from folded sections of tape or similar components which do not exhibit or are not characterized by aggressive or high tack-level adhesive properties which would otherwise permit the same to be adhered to the external surface portion of the release sheet 118. Accordingly, the pull-tabs 120 are interposed between the external surface portion of the adhesive layer 116 and the internal surface portion of the release sheet 118 so as to effectively ensure that the pull-tabs 120 do not prematurely separate from the external surface portion of the release sheet 118 whereby the same would obviously be ineffective, useless, or unable to be used for its intended purpose of facilitating the removal of the release sheet 118 from the undersurface portion of the adhesive layer 116.

In accordance with the aforenoted structural assembly, it has been experienced, however, that, as a result of the aforenoted structural assembly, that is, wherein the pull-tab 120 is interposed between the external surface portion of the adhesive layer 116 and the internal surface portion of the release sheet 118, when the pull-tab 120 is manually pulled so as to effectively separate and remove the release sheet 118 from the adhesive layer 116 disposed upon the undersurface portion of the base member 112 of the contamination-control mat assembly 110 so as to expose the adhesive layer 116 in preparation for securing the contamination-control mat assembly 110 to the underlying floor support structure, the pull-tab 120 is often difficult to separate from the adhesive layer 116. In particular, it is to be appreciated that not only is the pull-tab 120 adhered to or fixedly mounted upon the internal surface portion of the release sheet 118, but in addition, the pull-tab 120 likewise becomes adhered to or fixed upon the external surface portion of the underlying adhesive layer 116. In fact, the tack level or degree of adhesiveness defined between the pull-tab 120 and the underlying adhesive layer 116 is often greater than the tack level or degree of adhesiveness defined between the pull-tab 120 and the release sheet 118. Accordingly, when in fact the pull-tab 120 is manually manipulated so as to effectively attempt to separate and remove the release sheet 118 from the underlying adhesive layer 116, such separation and removal process is not necessarily readily able to be performed or achieved.

In particular, when it is attempted to separate and remove the release sheet 118 from the adhesive layer 116 disposed beneath the base member 112 of the contamination-control mat assembly 110, then as a result of the pull-tab 120 not only being adhered to the release sheet 118, but also being adhered to the underlying adhesive layer 116, the pull-tab 120 sometimes or often cannot in fact be separated from the underlying adhesive layer 116. Accordingly, the attempted separation of the pull-tab 120 from the underlying adhesive layer 116 results either in the tearing or ripping of the pull-tab 120 per se, leaving the release sheet 118 still adhered to the underlying adhesive layer 116 whereby the separation and removal of the release sheet 118 from the underlying adhesive layer 116 is rendered even more difficult to achieve, or alternatively, the attempted separation of the pull-tab 120 from the underlying adhesive layer 116 results in the tearing, separation, and removal of some of the underlying adhesive layer 116, along with the pull-tab 120, from the undersurface portion of the base member 112 whereby the adhesion of the base member 112, and therefore the adhesion of the entire contamination-control mat assembly 110 with respect to the underlying floor support structure, may be adversely affected.

A need therefore exists in the art for a new and improved pull-tab member, for use in combination with the release sheet covering the underlying adhesive layer disposed upon the undersurface portion of the base member of the contamination-control mat assembly, wherein the aforenoted operational difficulties or drawbacks, characteristic of conventional or PRIOR ART contamination-control mat assemblies, are effectively overcome whereby when the pull-tab member is manually grasped and manipulated so as to effectively remove the release sheet from the underlying adhesive layer disposed upon the undersurface portion of the base member of the contamination-control mat assembly, the pull-tab member will in fact remain intact and in place upon the release sheet, the release sheet will in fact be readily and easily removed from the underlying adhesive layer disposed upon the undersurface portion of the base member of the contamination-control mat assembly, and no portion of the underlying adhesive layer disposed upon the undersurface portion of the base member of the contamination-control mat assembly will be removed from the undersurface portion of the base member of the contamination-control mat assembly, such that the contamination-control mat assembly will be able to be properly and securely adhesively affixed to the underlying floor support structure.

### SUMMARY OF THE INVENTION

The aforenoted need is therefore submitted to be satisfied, in accordance with the principles and teachings of the present invention, through the provision of a pull-tab member which is adapted to be adhesively bonded to the external surface side of the release sheet, and wherein further, the relative tack level or degree of adhesiveness defined between the pull-tab member and the external surface side of the release sheet is greater than the relative tack level or degree of adhesiveness defined between the internal surface side of the release sheet and the underlying adhesive layer disposed upon the undersurface portion of the base member of the contamination-control mat assembly. In this manner, when the pull-tab member is manually grasped and manipulated so as to effectively remove the release sheet from the underlying adhesive layer disposed upon the undersurface portion of the base member of the contamination-control mat assembly, the pull-tab member will in fact remain intact and in place upon the external surface side of the release sheet, the release sheet will in fact be readily and easily removed from the underlying adhesive layer disposed upon the undersurface portion of the base member of the contamination-control mat assembly, and no portion of the underlying adhesive layer disposed upon the undersurface portion of the base member of the contamination-control mat assembly will be removed from the undersurface portion of the base member of the contamination-control mat assembly, whereby the contamination-control mat assembly will be able to be properly and securely adhesively affixed to the underlying floor support structure.

### BRIEF DESCRIPTION OF THE DRAWINGS

Various other objects, features, and attendant advantages of the present invention will be more fully appreciated from the following detailed description when considered in connection with the accompanying drawings in which like reference characters designate like or corresponding parts throughout the several views, and wherein:

FIG. 1 is a perspective view of a first type of conventional, PRIOR ART adhesively-coated contamination-control mat assembly comprising a plurality of stacked, layered, or laminated adhesive-coated pressure-sensitive sheets wherein pull-strands are utilized for separating individual adhesive-coated pressure-sensitive sheets from each other so as to effectively remove an uppermost soiled one of the pressure-sensitive sheets from the stacked assembly of adhesive-coated pressure-sensitive sheets so as to uncover a fresh, unsoiled one of the pressure-sensitive sheets disposed upon the stacked assembly of adhesive-coated pressure-sensitive sheets;

FIG. 2 is a perspective view of a second type of conventional, PRIOR ART adhesively-coated contamination-control mat assembly comprising a plurality of stacked, layered, or laminated adhesive-coated pressure-sensitive sheets wherein pull-tabs are utilized for separating individual adhesive-coated pressure-sensitive sheets from each other so as to likewise effectively remove an uppermost soiled one of the pressure-sensitive sheets from the stacked assembly of adhesive-coated pressure-sensitive sheets so as to uncover a fresh, unsoiled one of the pressure-sensitive sheets disposed upon the stacked assembly of adhesive-coated pressure-sensitive sheets;

FIG. 3 is a cross-sectional view of a third type of conventional, PRIOR ART adhesively-coated contamination-control mat assembly comprising a plurality of stacked, layered, or laminated adhesive-coated pressure-sensitive sheets wherein a pull-tab is interposed between the external surface portion of the adhesive layer disposed upon the undersurface portion of the base member of the contamination-control mat assembly and the internal surface portion of the release sheet covering the adhesive layer disposed upon the undersurface portion of the base member of the contamination-control mat assembly for removing the release sheet from the adhesive layer disposed upon the undersurface portion of the base member of the contamination-control mat assembly in order to permit adhesive fixation of the contamination-control mat assembly to an underlying floor support structure;

FIG. 4 is a cross-sectional view, similar to that of FIG. 3, showing, however, a new and improved adhesively-coated contamination-control mat assembly constructed in accordance with the principles and teachings of the present invention wherein a pull-tab is adhesively bonded upon the external surface side of the release sheet covering the adhesive layer disposed upon the undersurface portion of the base member of the contamination-control mat assembly, so as not to come into contact with the adhesive layer disposed upon the undersurface portion of the base member of the contamination-control mat assembly and thereby not be adhesively bonded thereto, whereby the release sheet is able to be readily and easily removed from the adhesive layer disposed upon the undersurface portion of the base member of the contamination-control mat assembly in preparation for the adhesive fixation of the contamination-control mat assembly to the underlying floor support structure;

FIG. 5 is a bottom plan view of the new and improved adhesively-coated contamination-control mat assembly as constructed in accordance with the principles and teachings of the present invention wherein the pull-tab is adhesively bonded upon the external surface side of the release sheet covering the adhesive layer disposed upon the under-surface portion of the base member of the contamination-control mat assembly;

FIG. 6 is a top plan view showing a plurality of the new and improved pull-tabs which are adhesively bonded upon a packaging release sheet prior to the separation of the pull-tabs from such packaging release sheet and the adhesive fixation of the same to the external surface side of the release sheet, for covering the adhesive layer disposed upon the undersurface portion of the base member of the contamination control mat assembly, as disclosed within FIG. 5; and

FIG. 7 is an enlarged cross-sectional view showing the laminated adhesive layer as disposed upon the internal surface portion of the pull-tab of the present invention and as disposed in contact with the release sheet which covers the adhesive layer, disposed beneath or upon the undersurface portion of the base member of the contamination-control mat assembly, prior to the removal of the release sheet in preparation for the fixation of the contamination-control mat assembly to the underlying floor support structure.

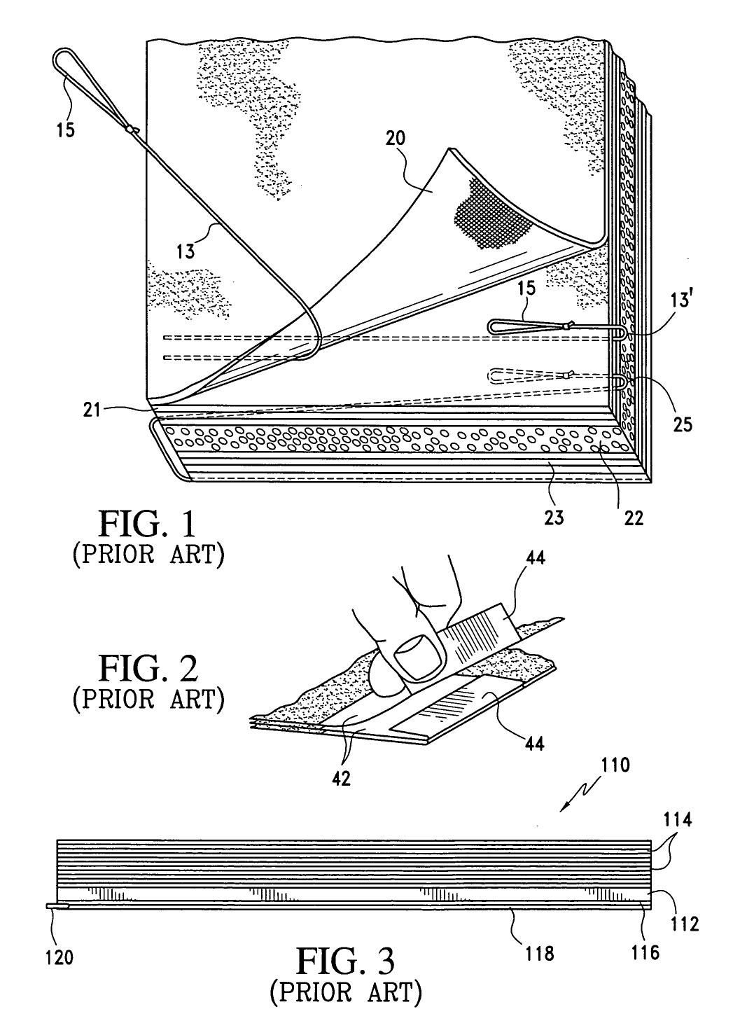

### DETAILED DESCRIPTION OF THE PREFERRED EMBODIMENT

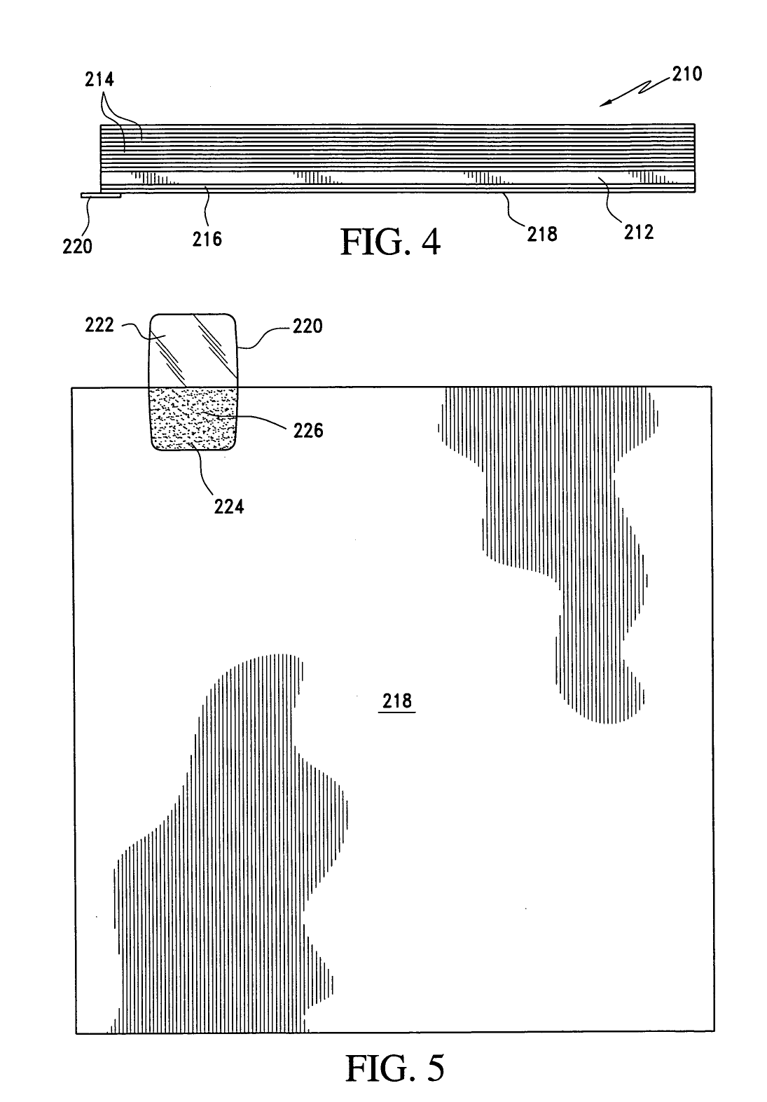

Referring now to the drawings, and more particularly to FIG. 4 thereof, a new and improved multi-layered, renewable, adhesive-coated, exposed-surface contamination-control mat assembly, constructed in accordance with the principles and teachings of the present invention, is disclosed and is generally indicated by the reference character 210. In view of the fact that the new and improved contamination-control mat assembly 210, as disclosed within FIG. 4, is similar to the conventional, PRIOR ART contamination-control mat assembly 110 as disclosed within FIG. 3, component parts of the new and improved contamination-control mat assembly 210 which are similar to the component parts of the conventional, PRIOR ART contamination-control mat assembly 110 will be designated by corresponding reference characters except that the reference characters will be within the 200 series. More particularly, the adhesive-coated, contamination-control mat assembly 210 is seen to comprise a base member 212 upon the upper surface of which there is disposed a stacked array of adhesive-coated plastic film sheets 214. In addition, in order to fixedly secure the contamination-control mat assembly 210 to an underlying floor support structure, the undersurface portion of the base member 212 has an adhesive layer 216 fixedly attached thereto. In addition, a release sheet 218 is normally disposed over or upon the external surface of the adhesive layer 216 so as to cover the same and thereby effectively prevent the adhesive material comprising the adhesive layer 216 from inadvertently sticking or adhering to any objects or structures prior to the intended adherence of the contamination-control mat assembly 210 to the underlying floor support structure.

In order to facilitate the removal of the release sheet 218 from the adhesive layer 216 disposed beneath or upon the undersurface portion of the base member 212 in preparation for the adherence of the contamination-control mat assembly 210 to the underlying floor support structure, a pull-tab 220 is mounted upon the contamination-control mat assembly 210 so as to be operatively connected to the underlying release sheet 218. More particularly, as can additionally be appreciated from FIG. 5, it is noted that in accordance with the structural arrangement characteristic of the new and improved contamination-control mat assembly 210 of the present invention, the pull-tab 220 is adhesively mounted and affixed upon the external surface portion of the release sheet 218 as opposed to the structural arrangement characteristic of the conventional, PRIOR ART contamination-control mat assembly 110 wherein the pull-tab 120 is interposed between the adhesive layer 116 and the release sheet 118 whereby the pull-tab 120 is not only adhesively bonded to the internal surface portion of the release sheet 118 but in addition is adhesively bonded to the external surface portion of the adhesive layer 116. As a result of this particularly noted disposition of the pull-tab 220 upon the external surface portion of the release sheet 218, it can be readily appreciated that the adverse operational difficulties, characteristic of the conventional, PRIOR ART contamination-control mat assembly 110, will effectively be overcome or prevented.

More particularly, in view of the fact that the pull-tab 220 is adhesively mounted and affixed upon the external surface portion of the release sheet 218, the pull-tab 220 normally does not engage or come into contact with the external surface portion of the underlying adhesive layer 216 of the base member 212 of the contamination-control mat assembly 210. Accordingly, when the release sheet 218 is to be removed from the underlying adhesive layer 216, the pull-tab 220 is simply manually grasped by means of installation personnel and appropriately manipulated so as to effectively peel off the release sheet 218 from the underlying adhesive layer 216 so as to expose the external surface portion of the adhesive layer 216 whereupon the exposed external surface portion of the adhesive layer 216 can then be adhesively bonded or affixed to the underlying floor support structure. In view of the fact that the pull-tab 220 is not engaged or disposed in contact with the underlying adhesive layer 216, no adhesive bonds exist between the pull-tab 220 and the underlying adhesive layer 216 whereby the release sheet 218 can be readily and easily separated from the underlying adhesive layer 216. In addition, the pull-tab 220 does not experience any tearing or ripping which would otherwise render the separation of the release sheet 218 from the underlying adhesive layer 216 difficult to achieve, and still further, no portion of the underlying adhesive layer 216 is inadvertently or undesirably removed from the undersurface portion of the base member 212 of the contamination-control mat assembly 210.

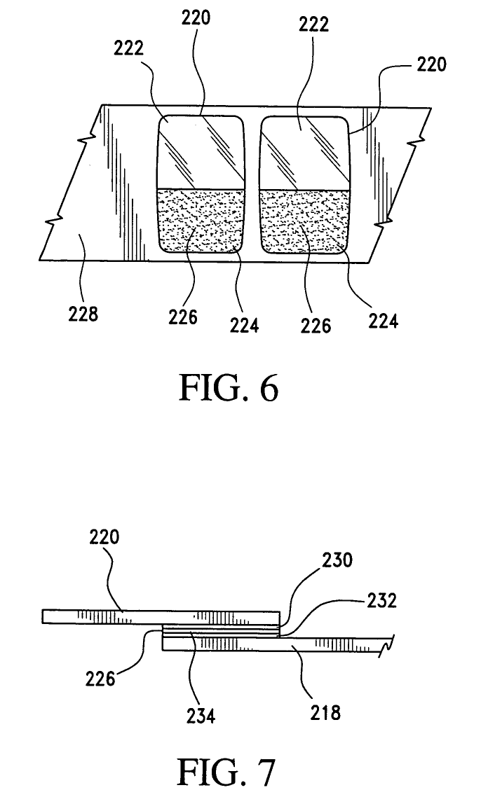

In accordance with the particular structural characteristics of each pull-tab 220 utilized in accordance with the principles and teachings of the present invention, and as can best be appreciated from FIGS. 5 and 6, each one of the pull-tabs 220 is seen to have a substantially rectangular or square configuration. In particular, each one of the pull-tabs 220 is effectively divided into an upper half-section 222 and a lower half-section 224. The lower half-section 224 has a suitable adhesive 226 disposed upon the internal surface portion thereof so as to adhesively affix the particular pull-tab 220 to the external surface side of the release sheet 218. It will be correspondingly appreciated that when the pull-tab 220 is adhesively affixed to the external side of the release sheet 218 by means of the adhesive-coated lower half-section 224 thereof, and upon an edge portion of the release sheet 218 as can best be appreciated from FIG. 5, the upper half-section 222 of the pull-tab 220 will effectively project outwardly from the edge portion of the release sheet 218 so as to be readily capable of being manually grasped and manipulated by means of installation personnel when it is desired to remove the release sheet 218 from the underlying adhesive layer 216. While the geometrical configuration of each one of the pull-tabs 220 has been disclosed as being substantially square or rectangular, other geometrical configurations are of course possible. If the pull-tab 220 is manufactured so as to have a substantially square configuration, each side of the square-shaped pull-tab 220 may be, for example, within the range of 0.75-1.50 inches.

If the pull-tab 220 is manufactured so as to have a substantially rectangular configuration, the long side or length dimension of each rectangularly-configured pull-tab 220 may be, for example, within the range of 1.00-1.50 inches, while the short side or width dimension of each rectangularly-configured pull-tab 220 may be, for example, within the range of 0.75-1.25 inches. The larger length and width dimensions will of course provide correspondingly larger amounts of surface area upon which the adhesive material 226 can be disposed upon the lower half-section 224 of each pull-tab 220, while correspondingly larger amounts of the surface area which define the upper half-section 222 of each pull-tab 220 will readily facilitate the grasping and manipulation of the pull-tab 220 in furtherance of its operational function for stripping or removing the release sheet 218 from the underlying adhesive layer 216 disposed upon the undersurface portion of the base member 212. It is to be noted further that the pull-tabs 220 may be fabricated from any one of a plurality of suitable thermoplastic materials, such as, for example, polyvinyl chloride (PVC), whereby, for example, the pull-tabs 220 may be clear, translucent or suitably colored. If the pull-tabs 220 are to be manufactured from colored thermoplastic materials, the pull-tabs 220 may have any color selected from the group comprising, for example, white, red, yellow, green, and blue.

With reference continuing to be made to FIG. 6, the pull-tabs 220 may be packaged en masse upon a suitable packaging release sheet or release liner 228. More particularly, the plurality of pull-tabs 220 are disposed, for example, within a side-by-side linear array formed upon the packaging release sheet or release liner 228, and it is to be noted that the packaging release sheet or release liner 228 may comprise, for example, a square-shaped or rectangularly-configured planar sheet, a rectangularly-configured planar strip, or a rectangularly-configured strip which is coiled into the form of a supply roll. It is to be noted still further that in accordance with the principles and teachings of the present invention, the adhesive 226 disposed upon the internal surface of each one of the pull-tabs 220 comprises an adhesive laminate. More particularly, as can best be appreciated from FIG. 7, the adhesive laminate 226 comprises a first adhesive layer 230, comprising a suitable rubber-based adhesive, which is disposed upon the internal surface portion of the pull-tab 220, a second adhesive layer 232, likewise comprising a suitable rubber-based adhesive, which is adapted to be disposed in contact with the packaging release sheet or release liner 228 and which will be disposed in contact with the release sheet 218 once the pull-tab 220 has been removed from the packaging release sheet or release liner 228 and transferred onto the release sheet 218, and a third intermediate layer 234 comprising, for example, a suitable polyester carrier.

It is also noted that the release sheet 218 is fabricated from a suitable thermoplastic material, such as, for example, textured polyethylene, and therefore, in accordance with the principles and teachings of the present invention, the adhesive material 226 disposed upon the internal surface portion of each pull-tab 220 must have a relative tack level or degree of adhesiveness, as defined between the pull-tab 220 and the external surface portion of the release sheet 218, which, contrary to the conventional or PRIOR ART pull-tab 120 as disclosed within FIG. 3, will enable the pull-tab 220 to be securely bonded to the external surface portion of the release sheet 218 such that the pull-tab 220 will not experience premature separation from the external surface portion of the release sheet 218. In addition, such relative tack level or degree of adhesiveness, as defined between the pull-tab 220 and the external surface portion of the release sheet 218, should be substantially greater or higher than the relative tack level or degree of adhesiveness as defined between the internal surface portion of the release sheet 218 and the underlying adhesive layer 216 disposed upon the external surface portion of the base member 212 of the contamination-control mat assembly 210. In this manner, when the pull-tab 220 is manually gripped and manipulated so as to effectively remove the release sheet 218 from the underlying adhesive layer 216 disposed upon the undersurface portion of the base member 212 of the contamination-control mat assembly 210, the pull-tab 220 will not be torn or ripped, and the pull-tab 220 will in fact remain intact and in place upon the external surface portion of the release sheet 218.

In turn, the release sheet 218 will in fact be readily and easily removed from the underlying adhesive layer 216 disposed upon the undersurface portion of the base member 212 of the contamination-control mat assembly 210, and no portion of the underlying adhesive layer 216 disposed upon the undersurface portion of the base member 212 of the contamination-control mat assembly 210 will be removed from the undersurface portion of the base member 212 of the contamination-control mat assembly 210, whereby the contamination-control mat assembly 210 will be able to be properly and securely adhesively affixed to the underlying floor support structure. In order to achieve the aforenoted desirable operational characteristics, the relative tack level or degree of adhesiveness as defined between the aforenoted first adhesive layer 230, comprising the suitable rubber-based adhesive, which is disposed in contact with the internal surface portion of the pull-tab 220, as well as the relative tack level or degree of adhesiveness as defined between the aforenoted second adhesive layer 232, which likewise comprises the suitable rubber-based adhesive, which is adapted to be disposed in contact with the packaging release sheet or release liner 228 and which will be disposed in contact with the release sheet 218 once the pull-tab 220 has been removed from the packaging release sheet or release liner 228 and transferred onto the release sheet 218, is within the range of 100-250 ounces, with a preferred relative tack level or degree of adhesiveness being 175 ounces.

While the relative tack level or degree of adhesiveness as defined between the aforenoted first adhesive layer 230, comprising the suitable rubber-based adhesive, which is disposed in contact with the internal surface portion of the pull-tab 220, as well as the relative tack level or degree of adhesiveness as defined between the aforenoted second adhesive layer 232, which likewise comprises the suitable rubber-based adhesive, which is adapted to be disposed in contact with the packaging release sheet or release liner 228 and which will be disposed in contact with the release sheet 218 once the pull-tab 220 has been removed from the packaging release sheet or release liner 228 and transferred onto the release sheet 218, are preferably equal, they do not necessarily need to be precisely equal. The only requirement is that each relative tack level or degree of adhesiveness, characteristic of the first and second adhesive layers 230,232, be substantially or significantly higher or greater than the relative tack level or degree of adhesiveness as defined between the release sheet 218 and the underlying adhesive layer 216 disposed beneath or upon the undersurface portion of the base member 212 of the contamination-control mat assembly 210. In this manner, not only will such facilitate and ensure the desired removal of the release sheet 218 from the underlying adhesive layer 216, but in addition, such will effectively prevent the undesirable premature separation of the pull-tab 220 from release sheet 218 as a result of a failure within the adhesive bond defined between the pull-tab 220 and the first adhesive layer 230, as well as a failure within the adhesive bond defined between the second adhesive layer 232 and the release sheet 218. It is to be lastly noted, with respect to the particular tack levels or degrees of adhesiveness characteristic of the first and second adhesive layers 230,232, that despite the aggressive adhesion of each pull-tab 220 upon the external surface portion of the release sheet 218, such tack levels or degrees of adhesiveness do not present any problems or difficulties in connection with the removal of the pull-tabs 220 from the packaging release sheet or release liner 228 in view of the fact that the packaging release sheet or release liner 228 is fabricated from a suitable silicone-coated material, or alternatively, the release liner or release sheet 228 may be coated with polytetrafluoroethylene (TEFLON®).

Lastly, in connection with each one of the adhesive-coated plastic film sheets comprising the stacked array of adhesive-coated plastic film sheets 214, each one of the adhesive-coated plastic film sheets comprises an adhesive-coated surface upon which “clean-room” personnel walk or tread prior to entering the “clean-room” facility, or upon or over which apparatus, such as, for example, wheeled carts or the like, are moved such that dirt and debris disposed upon the wheels of such apparatus, or dirt or debris disposed upon the shoes of the “clean-room” personnel, can be removed. More particularly in connection with the actual fabrication of the stacked array or laminate of adhesive-coated plastic film sheets 214, comprising, of course, the multitude of individual sheets having the adhesive-coated surfaces respectively integrally formed thereon for performing the aforenoted dirt and debris removal operations, the structure or make-up of the multi-layered stack or laminate of adhesive-coated plastic film sheets 214, and that of each one of the multitude of individual sheets, may be derived from or similar to the tack mat stack and individual sheets as disclosed, for example, within U.S. Pat. No. 4,559,250 which issued to Paige on Dec. 17, 1985.

More particularly, each one of the individual sheets, comprising the multi-layered stack or laminate of adhesive-coated sheets 214, may be fabricated, for example, from high-density polyethylene (HDPE), linear low-density polyethylene (LLDPE), or non-linear low-density polyethylene (LDPE). High-density polyethylene (HDPE) film typically has a film tensile strength of 4800 psi, ASTM test method D882, which is sufficient to withstand an adhesive pull load from an underlying film layer of ten ounces per lineal inch of width, while linear low-density polyethylene (LLDPE) film typically has a film tensile strength of 6000 psi which, again, is sufficient to withstand ten ounces of adhesion per inch of width without tearing, and non-linear low-density polyethylene (LDPE) film typically has a film tensile strength of 2800 psi. Each one of the sheets, comprising the multi-layered stack or laminate of adhesive-coated sheets 214, can have a thickness dimension which is within the range of 0.4 mil to 2.5 mils, and a thickness dimension of 1.0 mil is preferred. It is noted that if a film, having a thickness dimension of less than 1.0 mil, is to be used, the adhesive pull load must be accordingly reduced. For example, if a film having a thickness dimension of 0.4 mil is to be used, the adhesive pull load must be within the range of five ounces or less. It is also to be noted that it is more economical to use a relatively thin film in that plastic films are normally priced as a function of weight, such as, for example, per pound. Since a 1.0 mil film effectively yields three times the amount of working-surface area of film per pound as that of a 3.0 mil film, then a sheet of film, having a predetermined surface area, would be three times more expensive when produce as a film having a thickness dimension of 3.0 mils than a similar sheet of film having a thickness dimension of 1.0 mil.

In order to ensure that the exposed adhesive material will strongly adhere to the external surface of the polyethylene film so as to serve its intended dirt or debris removal functions, it is necessary to effectively distress the ordinarily smooth surface of the film. This distressing treatment of the film surface is accomplished by subjecting the film surface to a high electronic discharge which is commonly known as corona treatment. If the film surface is not in fact subjected to such corona treatment, the adhesive material would tend to rub off from the plastic film or to undesirably adhere and be transferred to the object which comes into contact or engagement with such adhesive material. Still further, while it is important to facilitate the separation of the individual sheets, comprising the multi-layered stack or laminate of adhesive-coated sheets 214, from each other when desired such that, for example, an old or used sheet of the contamination-control mat assembly 210 can be removed from the underlying multi-layered stack or laminate of adhesive-coated sheets 214 whereby a new or fresh sheet of the underlying multi-layered stack or laminate of adhesive-coated sheets 214 of the contamination-control mat assembly 210 can be exposed, it is also important to prevent premature delamination or separation of the individual sheets of the multi-layered stack or laminate of adhesive-coated plastic film sheets 214 from each other so as not to adversely affect the continued use of the contamination-control mat assembly 210 by permitting the individual sheets of the multi-layered stack or laminate of adhesive-coated sheets 214 to be successively and individually exposed. Accordingly, the non-adhesive or uncoated side of each one of the sheets, comprising the multi-layered stack or laminate of adhesive-coated sheets 214, is likewise subjected to the aforenoted electronic or corona treatment, as a result of which, the non-adhesive or uncoated sides of the plastic sheets adhere more strongly to the underlying adhesive-coated sides or surfaces of the plastic sheets whereby the sheets of the contamination-control mat assembly 210 are held tightly together and effectively prevented from undergoing or exhibiting premature delamination.

Continuing still further, it is to be noted that the electronic corona treatment process results in a treatment level which effectively produces a force, which can of course be measured in dynes, by means of which the adhesive material is coated and bound upon the plastic film. A tendyne treatment level, or a twenty-dyne treatment level, is less disruptive to a plastic film surface than a forty-dyne treatment level, and accordingly, adhesive material which is coated upon a plastic film surface by means of a forty-dyne treatment level will be bound more tightly to the electronic corona-treated surface of the film than adhesive material which is coated upon the plastic film surface by means of a ten or twenty-dyne treatment level. Accordingly, still further, it is to be further appreciated that when adhesive material is coated onto a plastic film surface by means of a predetermined dyne treatment level, and when such adhesive-coated film surface is laminated to a plastic film surface which has not been coated with adhesive material but which also been subjected to an electronic corona treatment process at the same predetermined dyne treatment level, the adhesive material will adhere just as tightly to the non-coated corona-treated plastic film surface as it will adhere to plastic film surface upon which it has been originally coated. Therefore, it has been experienced that when both plastic film surfaces have been treated by means of, for example, forty-dyne treatment levels, the two film surfaces will not readily separate from each other whereby the films per se exhibiting tearing, or the adhesive material being partially delaminated from the film surface upon which it was originally coated.

Conversely, when both plastic film surfaces have been treated by means of, for example, ten or twenty-dyne treatment levels, the two film surfaces are able to be readily separated from each other without the films per se exhibiting tearing, or without the adhesive material being partially delaminated from the film surface upon which it was originally coated. Therefore, according to the principles and teachings of the present invention, the plastic film sheets can have adhesive material coated upon one side or surface thereof, the plastic film sheets can effectively be adhered to each other, or held together, so as to form the multi-sheet or multi-layered stack or laminate of adhesive-coated sheets 214, and yet, the plastic film sheets can be readily separated and released from each other as a result of properly controlling the electronic corona discharge treatment level.

In connection with the proper control of the electronic corona discharge treatment levels to be impressed upon both the adhesive-coated and non-coated sides or surfaces of the film sheets, it is noted further that the two sides or surfaces of each film sheet need not be treated with the same dyne treatment level. For example, the non-coated side or surface of each film sheet may be subjected to a dyne treatment level which is approximately one half that of the dyne treatment level to which the adhesive-coated side or surface of each film sheet is subjected. This relative treatment level relationship, as defined between the non-coated and adhesive-coated sides or surfaces of each film sheet, thus provides the necessary adherence of the individual film sheets, of the multi-sheet or multi-layered stack or laminate of adhesive-coated sheets 214, to each other while nevertheless permitting the individual film sheets, of the multi-sheet or multi-layered stack or laminate of adhesive-coated sheets 214, to be separated or released from each other when desired. In accordance with such dyne treatment levels of both the non-coated and adhesive-coated sides or surfaces of the film sheets, it is also noted that the particular treatment level for a particular one of the sides or surfaces of the film sheets may be varied, as may the relative proportion or ratio of the treatment levels for the opposite sides or surfaces of the film sheets, in order to in fact achieve the aforenoted optimum results. While optimum results may vary in connection with different plastic films, such as, for example, dependent upon the chemical composition of the plastic film per se, or the chemical composition of the particular adhesive and cross-linking materials, as well as the relative percentages by weight of the adhesive and cross-linking materials within the adhesive composition, being used upon the particular plastic film, it has been found that in order to achieve such optimum results for various plastic films, the adhesive-coated side or surface of each plastic film sheet is preferably treated at an electronic corona discharge treatment level which is within the range of 40-50 dynes, while the non-coated side or surface of each plastic film sheet is preferably treated at an electronic corona discharge treatment level which is within the range of 10-30 dynes.

Thus, it may be seen that in accordance with the principles and teachings of the present invention, there has been disclosed and described a pull-tab which is adapted to be adhesively bonded to the external surface portion of the release sheet, and wherein further, the relative tack level or degree of adhesiveness defined between the pull-tab and the external surface portion of the release sheet is greater than the relative tack level or degree of adhesiveness defined between the internal surface portion of the release sheet and the underlying adhesive layer disposed upon the undersurface portion of the base member of the contamination-control mat assembly. In this manner, when the pull-tab member is manually grasped and manipulated so as to effectively remove the release sheet from the underlying adhesive layer disposed upon the undersurface portion of the base member of the contamination-control mat assembly, the pull-tab member will in fact remain intact and in place upon the external surface side of the release sheet, the release sheet will in fact be readily and easily removed from the underlying adhesive layer disposed upon the undersurface portion of the base member of the contamination-control mat assembly, and no portion of the underlying adhesive layer disposed upon the undersurface portion of the base member of the contamination-control mat assembly will be removed from the undersurface portion of the base member of the contamination-control mat assembly, whereby the contamination-control mat assembly will be able to be properly and securely adhesively affixed to the underlying floor support structure.

Obviously, many variations and modifications of the present invention are possible in light of the above teachings. It is therefore to be understood that within the scope of the appended claims, the present invention may be practiced otherwise than as specifically described herein.

1. A release sheet assembly for covering an adhesive layer disposed upon an undersurface portion of a contamination-control mat assembly to be adhesively secured to an underlying floor support structure, comprising:
release sheet means having an internal surface portion for removable disposition upon an adhesive layer, disposed upon an undersurface portion of a contamination-control mat assembly to be adhesively secured to an underlying floor support structure, so as to protectively cover the adhesive layer disposed upon the undersurface portion of the contamination-control mat assembly prior to the time at which it is desired to adhesively secure the contamination-control mat assembly to the underlying floor support structure by means of the adhesive layer disposed upon the undersurface portion of the contamination-control mat assembly, and for uncovering the adhesive layer disposed upon the undersurface portion of the contamination-control mat assembly, when it is desired to adhesively secure the contamination-control mat assembly to the underlying floor support structure by means of the adhesive layer disposed upon the undersurface portion of the contamination-control mat assembly, so as to permit the contamination-control mat assembly to be affixed to the underlying floor support structure as a result of the adhesive bonding of the adhesive layer, disposed upon the undersurface portion of the contamination-control mat assembly, to the underlying floor support structure; and
pull-tab means, fixedly mounted upon an external surface portion of said release sheet means so as not to be engageable with the adhesive layer disposed upon the undersurface portion of the contamination-control mat assembly when the release sheet means is removably disposed upon the adhesive layer disposed upon the undersurface portion of the contamination-control mat assembly, for readily facilitating the removal of said release sheet means from the adhesive layer disposed upon the undersurface portion of the contamination-control mat assembly.

2. The release sheet assembly as set forth in claim 1, further comprising:
adhesive means for adhesively bonding said pull-tab means to said external surface portion of said release sheet means.

3. The release sheet assembly as set forth in claim 1, wherein:
said pull-tab means is adhesively bonded to said external surface portion of said release sheet means within the vicinity of a peripheral edge portion of said release sheet means.

4. The release sheet assembly as set forth in claim 3, wherein:
said pull-tab means has a substantially rectangular configuration having a predetermined length dimension and a predetermined width dimension;
a first half-portion of said pull-tab means is adhesively bonded to said external surface portion of said release sheet means within said vicinity of said peripheral edge portion of said release sheet means; and
a second half-portion of said pull-tab means projects outwardly beyond said peripheral edge portion of said release sheet means so as to be readily capable of being grasped and manually manipulated in order to remove said release sheet means from the adhesive layer disposed upon the undersurface portion of the contamination-control mat assembly.

5. The release sheet assembly as set forth in claim 1, wherein:
said pull-tab means is fabricated from a thermoplastic material.

6. The release sheet assembly as set forth in claim 5, wherein:
said thermoplastic material, from which said pull-tab means is fabricated, comprises polyvinyl chloride (PVC).

7. The release sheet assembly as set forth in claim 5, wherein:
said pull-tab means is fabricated from a thermoplastic material which is selected from the group comprising clear, translucent, and colored thermoplastic materials.

8. The release sheet assembly as set forth in claim 7, wherein:
said colored thermoplastic material has a color which is selected from the group comprising white, red, yellow, green, and blue.

9. The release sheet assembly as set forth in claim 1, wherein:
said release sheet means is fabricated from a thermoplastic material.

10. The release sheet assembly as set forth in claim 2, wherein:
said release sheet means is fabricated from textured polyethylene; and
said adhesive means, for adhesively bonding said pull-tab means to said external surface portion of said release sheet means, is characterized by a relative tack level, as defined between said release sheet means and said pull-tab means, which is within the range of 100-250 ounces.

11. The release sheet assembly as set forth in claim 10, wherein:
said relative tack level of said adhesive means, as defined between said release sheet means and said pull-tab means, is preferably 175 ounces.

12. A pull-tab packaging assembly for containing at least one pull-tab to be fixedly mounted upon an external surface portion of a release sheet which is to be removably disposed over an adhesive layer disposed upon an undersurface portion of a contamination-control mat assembly to be adhesively secured to an underlying floor support structure, comprising:
a packaging release liner; and
at least one pull-tab means, removably mounted upon said packaging release liner and adapted to be fixedly mounted upon the external surface portion of the release sheet so as not to be engageable with the adhesive layer disposed upon the undersurface portion of the contamination-control mat assembly when the release sheet is removably disposed upon the adhesive layer disposed upon the undersurface portion of the contamination-control mat assembly, for readily facilitating the removal of said release sheet means from the adhesive layer disposed upon the undersurface portion of the contamination-control mat assembly.

13. The packaging assembly as set forth in claim 12, wherein:
said at least one pull-tab means comprises a plurality of pull-tab means disposed within a linear array upon said packaging release liner.

14. The packaging assembly as set forth in claim 13, further comprising:
adhesive means for adhesively bonding each one of said plurality of pull-tab means to said packaging release liner.

15. The packaging assembly as set forth in claim 14, wherein:
said packaging release liner is coated with a material selected from the group comprising silicone and polytetrafluoroethylene (TEFLON®); and
said adhesive means, for adhesively bonding each one of said plurality of pull-tab means to said packaging release liner, is characterized by a relative tack level which will enable each one of said plurality of pull-tab means to be removed from said packaging release liner but which will enable each one of said plurality of pull-tab means to be fixedly bonded to the external surface portion of the release sheet covering the adhesive layer disposed upon the undersurface portion of the contamination-control mat assembly to be adhesively secured to the underlying floor support structure so as not to be removable from the external surface portion of the release sheet covering the adhesive layer disposed upon the undersurface portion of the contamination-control mat assembly to be adhesively secured to the underlying floor support structure.

16. The packaging assembly as set forth in claim 15, wherein:
said relative tack level of said adhesive means is within the range of 100-250 ounces.

17. The packaging assembly as set forth in claim 16, wherein:
said relative tack level of said adhesive means is preferably 175 ounces.

18. A contamination-control mat assembly to be adhesively secured to an underlying floor support structure, comprising:
a base member;
a stacked array of pressure-sensitive adhesive-coated sheets disposed upon an upper surface portion of said base member;
an adhesive layer disposed upon an undersurface portion of said base member for adhesively securing said contamination-control mat assembly to the underlying floor support structure;
release sheet means, having an internal surface portion for removable disposition upon said adhesive layer, for protectively covering said adhesive layer prior to the time at which it is desired to adhesively secure said contamination-control mat assembly to the underlying floor support structure by means of said adhesive layer, and for uncovering said adhesive layer disposed upon said undersurface portion of said contamination-control mat assembly, when it is desired to adhesively secure said contamination-control mat assembly to the underlying floor support structure by means of said adhesive layer, so as to permit said contamination-control mat assembly to be affixed to the underlying floor support structure as a result of the adhesive bonding of said adhesive layer to the underlying floor support structure; and
pull-tab means, fixedly mounted upon an external surface portion of said release sheet means so as not to be engageable with said adhesive layer disposed upon said undersurface portion of said contamination-control mat assembly when said release sheet means is removably disposed upon said adhesive layer disposed upon said undersurface portion of said contamination-control mat assembly, for readily facilitating the removal of said release sheet means from said adhesive layer disposed upon said undersurface portion of said contamination-control mat assembly.

19. The contamination-control mat assembly as set forth in claim 18, further comprising:
adhesive means for adhesively bonding said pull-tab means to said external surface portion of said release sheet means.

20. The contamination-control mat assembly as set forth in claim 18, wherein:
said pull-tab means is adhesively bonded to said external surface portion of said release sheet means within the vicinity of a peripheral edge portion of said release sheet means.

21. The contamination-control mat assembly as set forth in claim 20, wherein:
said pull-tab means has a substantially rectangular configuration having a predetermined length dimension and a predetermined width dimension;
a first half-portion of said pull-tab means is adhesively bonded to said external surface portion of said release sheet means within said vicinity of said peripheral edge portion of said release sheet means; and
a second half-portion of said pull-tab means projects outwardly beyond said peripheral edge portion of said release sheet means so as to be readily capable of being grasped and manually manipulated in order to remove said release sheet means from the adhesive layer disposed upon the undersurface portion of the contamination-control mat assembly.

22. The contamination-control mat assembly as set forth in claim 18, wherein:
said pull-tab means is fabricated from a thermoplastic material.

23. The contamination-control mat assembly as set forth in claim 22, wherein:
said thermoplastic material, from which said pull-tab means is fabricated, comprises polyvinyl chloride (PVC).

24. The contamination-control mat assembly as set forth in claim 22, wherein:
said pull-tab means is fabricated from a thermoplastic material which is selected from the group comprising clear, translucent, and colored thermoplastic materials.

25. The contamination-control mat assembly as set forth in claim 24, wherein:
said colored thermoplastic material has a color which is selected from the group comprising white, red, yellow, green, and blue.

26. The contamination-control mat assembly as set forth in claim 18, wherein:
said release sheet means is fabricated from a thermoplastic material.

27. The contamination-control mat assembly as set forth in claim 19, wherein:
said release sheet means is fabricated from textured polyethylene; and
said adhesive means, for adhesively bonding said pull-tab means to said external surface portion of said release sheet means, is characterized by a relative tack level, as defined between said release sheet means and said pull-tab means, which is within the range of 100-250 ounces.

28. The contamination-control mat assembly as set forth in claim 27, wherein:
said relative tack level of said adhesive means, as defined between said release sheet means and said pull-tab means, is preferably 175 ounces.

29. The contamination-control mat assembly as set forth in claim 19, wherein:
said relative tack level of said adhesive means, as defined between said release sheet means and said pull-tab means, is greater than the tack level defined between said release sheet means and said adhesive layer disposed upon said undersurface portion of said base member so as to readily permit said release sheet means to be removed from said adhesive layer disposed upon said undersurface portion of said base member while preventing said pull-tab means from separating from said release sheet means when said pull-tab means is manually manipulated to remove said release sheet means from said adhesive layer disposed upon said undersurface portion of said base member.
